(19) United States
(12) Patent Application Publication
(10) Pub. No.: US 2009/0150700 A1
(43) Pub. Date: Jun. 11, 2009

(54) METHOD OF CONTROLLING POWER TO A PLURALITY OF SERVERS

(75) Inventor: Ivan Dell'Era, Shirley, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/951,412

(22) Filed: Dec. 6, 2007

(51) Int. Cl. G06F 1/32

(52) U.S. Cl. 713/324

(57) ABSTRACT

A method of controlling power to a plurality of servers operating in a virtualization mode. The method includes monitoring a demand for resources from the plurality of physical servers. Upon sensing a decrease in demand for resources from the plurality of physical servers, select ones of the plurality of virtual servers are migrated from one or more of the plurality of physical servers to others of the plurality of physical servers. The physical severs from which the plurality of virtual servers have migrated are designated as inactive physical servers and powered off, and the others of the physical servers are designated as active physical servers. Upon sensing an increase in demand for resources from the plurality of active physical servers, the inactive physical servers are powered up and select ones of the plurality of virtual severs are migrated back to the powered-up inactive physical servers.

### BACKGROUND OF THE INVENTION

1. Field of the Invention

This invention relates to the art of computer servers and, more particularly, to a method of controlling power to a plurality of computer servers operating in a virtualization mode.

2. Description of Background

Virtualization is a method of partitioning a physical computer server into multiple servers, each having the appearance and capabilities of running on its own dedicated machine. Each virtual server can run its own full-fledged operating system, and each server can be independently rebooted. Virtualization reduces a need for a large number of physical servers by creating several virtual servers running on a single physical box. Virtual servers are used to maintain a separation between users of various software programs and computer hardware. In operation, the physical server boots normally. Once the physical server has booted, a program is initialized that boots each virtual server independently. In this manner, virtual servers have no direct access to machine hardware.

In addition to providing a measure of security by separating software and hardware components, virtualization can accommodate an increase in server utilization during peak hours. For example, during peak hours servers can experience an approximately 60%-80% increase in utilization. Virtualization spreads utilization across multiple machines thereby accommodating a large number of users. However, during off-peak hours, e.g., late at night, weekends, holidays, etc., server utilization often times drops below 20%. The need for multiple serves is less, however, even during these off-peak hours, the physical servers are supplied power. That is, even though many of the physical servers are inactive, they are still consuming power. Over time, the energy wasted by operating servers unnecessary can represent a significant cost impact for a company.

### SUMMARY OF THE INVENTION

The shortcomings of the prior art are overcome and additional advantages are provided through the provision of a method of controlling power to a plurality of servers operating in a virtualization mode. The method includes monitoring a demand for resources from a plurality of physical servers each of which includes a plurality of virtual servers. Upon sensing a decrease in demand for resources from the plurality of physical servers, select ones of the plurality of virtual servers are migrated from one or more of the plurality of physical servers to others of the plurality of physical servers. The physical severs from which the select ones of the plurality of virtual servers have migrated are designated as inactive physical severs, and the others of the physical servers to which the select ones of the plurality of virtual servers have migrated are designated as active physical servers. The inactive physical servers are then powered-off. Upon sensing an increase in demand for resources from the plurality of active physical servers, the inactive physical servers are powered up to establish powered-up inactive physical servers and select ones of the plurality of virtual severs are migrated from the active physical servers to the powered-up inactive physical servers.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a plurality of networked physical servers operating in a virtualization mode and controlled by a method of controlling power to a plurality of servers in accordance with an exemplary embodiment of the present invention; and

FIG. 2 is a flow chart illustrating a method of controlling power to a plurality of servers in accordance with an exemplary embodiment of the present invention.

The detailed description explains the exemplary embodiments of the invention, together with advantages and features, by way of example with reference to the drawings.

### DETAILED DESCRIPTION OF THE INVENTION

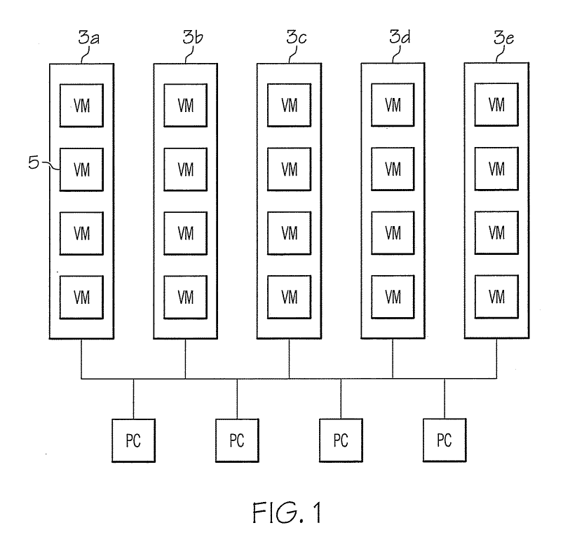

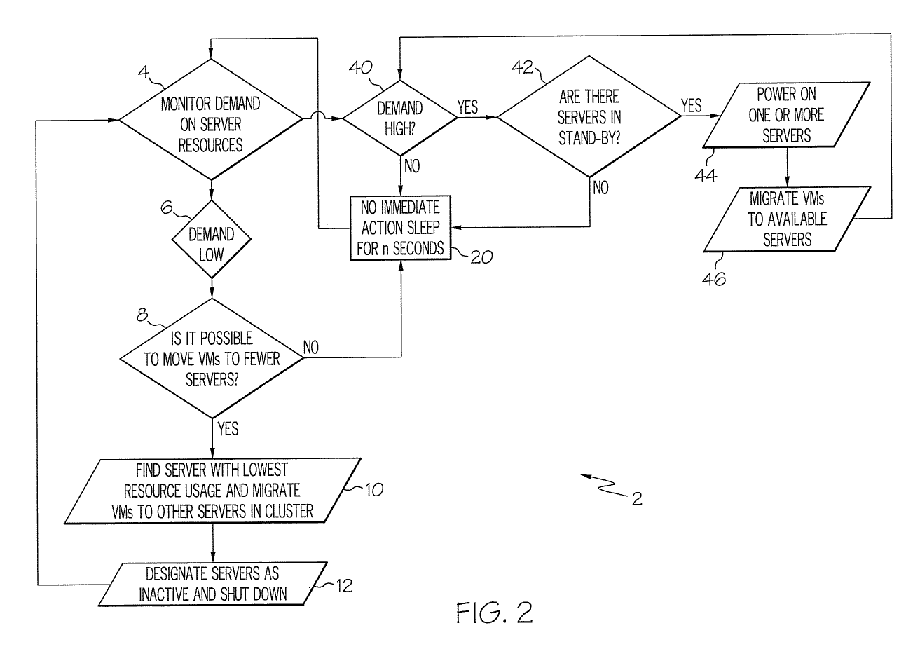

With initial reference to FIGS. 1 and 2 a method of controlling power to a plurality of physical servers in accordance with an exemplary embodiment of the present invention is generally indicated at 2. During peak and off-peak hours, demand for resources on a plurality of physical servers such as indicated at 3a-3e running in a virtualization mode is monitored as indicated in block 4. More specifically, each of the plurality of physical servers 3a-3e is running software that establishes a plurality of virtual servers or VM's, indicated generally at 5 in connection with physical sever 3a. An agent monitors resource utilization, such as by monitoring central processing unit (CPU) access time, memory allocation etc., currently in use on each of the plurality of physical servers 3a-3e. If demand is seen to be low, such as during off-peak hours, indicated in block 6, a determination is made as to whether it is possible to move one or more of the virtual servers to fewer physical servers in block 8. If it is possible to move virtual servers to fewer servers, the physical server having the lowest resource allocation is located, and select ones of the virtual servers are migrated from the physical server identified as having the lowest resource usage, as indicated in block 10. When all virtual servers are removed from a physical server, the physical server is designated as an inactive server and powered down, i.e., placed in a standby mode such as indicated in block 12. At this point, the agent continues to monitor demand until all of the virtual servers are consolidated onto the fewest possible number of physical servers. In this manner, multiple physical servers can be powered down to save energy usage. Alternatively, if in block 8 it is determined that it is impossible to move virtual servers to fewer servers, no immediate action is taken and monitoring is suspended for a predetermined time period as indicated in block 20.

When the agent determines that resource demand is again, high such as during peak hours as indicated in block 40, a determination is made as to whether any of the physical servers are in a power down or standby mode in block 42. That is, after consolidating some or all of the virtual servers to the fewest number of physical servers during low usage periods, a high usage period may develop that requires the resources of a greater number of physical servers. Thus, once a determination is made that there are servers in standby mode in block 42, inactive or shutdown servers are powered on, booted up and made ready to receive virtual servers in block 44. At this point, select ones of the virtual servers are moved from active physical servers to the now powered up inactive physical servers in block 46. In this manner, power resources employed to operates the physical servers is maintained at energy efficient levels.

At this point, it should be understood that during low usage periods, virtual servers that are in use are migrated to the fewest number of physical servers. However, once demand for server resources increases, inactive physical servers previously placed in standby mode are reactivated and the virtual servers are redistributed to meet resource demand during high usage periods. Servers in standby mode can be powered up by sending a wake on LAN request to the physical machine or through other hardware or software devices. Virtual servers are distributed among the physical servers such that resource allocation is balanced between each of the plurality of physical servers currently in operation. Of course, if the demand remains low, or no physical servers are in stand-by mode, no action is taken and monitoring is suspended for a predetermined period of time as indicated in block 20. Once the predetermined period lapses, monitoring resumes. Thus, the present invention provides a system that maintains physical server usage at efficient power levels in order to conserve resources and minimize energy usage to maintain energy consumption resource means at cost efficient levels.

It should also be understood that the capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

Finally, it should be appreciated that the flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of controlling power to a plurality of servers operating in a virtualization mode, the method comprising:
monitoring a demand for resources from a plurality of physical servers operating in a virtualization mode, each of the plurality of physical servers including a plurality of virtual servers,
wherein, upon sensing a decrease in the demand for resources from the plurality of physical servers:
migrating select ones of the plurality of virtual servers from one or more of the plurality of physical servers to others of the plurality of physical servers;
designating the one or more physical servers from which the select ones of the virtual servers have migrated as inactive physical severs;
designation the other of the physical servers to which the select ones of the virtual severs have migrated as active physical servers; and
powering off the inactive physical servers; and
wherein, upon sensing an increase in demand for resources from the plurality of active physical servers:
powering up the inactive physical servers to establish powered-up inactive physical servers; and
migrating select ones of the plurality of virtual severs from the active physical servers to the powered-up inactive physical servers.

2. The method according to claim 1, wherein migrating select ones of the plurality of virtual severs from the active physical servers to the powered-up inactive physical servers includes balancing resource allocation between the powered-up inactive physical servers.

3. The method according to claim 1, further comprising:
identifying the one of the plurality of physical servers having a lowest resource usage; and
migrating select ones of the plurality of virtual servers from the physical server having the lowest resources usage.
